(19) United States
(12) Patent Application Publication
(10) Pub. No.: US 2015/0056953 A1
(43) Pub. Date: Feb. 26, 2015

(54) Instant Communication System

(71) Applicant: Chaatz Limited, Wan Chai (HK)

(72) Inventors: Richard Lap Tak Cheung, New Territories (HK); Hon Wai Wong, Kowloon (HK); Man Pok Chung, Mid-levels (HK)

(73) Assignee: Chaatz Limited, Wan Chai (HK)

(21) Appl. No.: 14/023,949

(22) Filed: Sep. 11, 2013

(30) Foreign Application Priority Data
Aug. 21, 2013 (HK) 13109790.8

(51) Int. Cl. H04W 4/16; H04W 12/08; H04W 4/12

(52) U.S. Cl. CPC H04W 4/16; H04W 4/12; H04W 12/08
USPC 455/411; 455/415

(57) ABSTRACT

An instant communication system comprising an instant communication server, a plurality of mobile terminals, and a communication network is provided; the instant communication server includes an instant communication server processor and an instant communication server memory electrically connected to the instant communication server processor; each of the mobile terminals includes a terminal central processor, a terminal communication processor, a display unit, a terminal memory, and at least one information storage unit configured for storing a CID (Calling ID); the terminal central processor is electrically connected with the display unit and the terminal communication processor respectively; the terminal communication processor is further electrically connected with the information storage unit to obtain the CID. The following advantageous effect can be achieved: communications using different phone numbers of one mobile terminal can be distinguished from each other.

### FIELD OF THE INVENTION

The present application relates to the field of communication, and more particularly relates to an instant communication system.

### BACKGROUND OF THE INVENTION

In order to avoid mutual interferences generated between affairs in lives and affairs in works, many persons possess several cell phones, or possess a cell phone having some different phone numbers (e.g., a cell phone have a dual SIM card mode) and use the different phone numbers to respectively aim at different groups (e.g., a friend group, a workmate group, a partner group, and so on). However, at present, most cell phones are equipped with information transceivers, and a MTID (Mobile Terminal ID) of an information transceiver needs to be registered by a user and doesn't relate to a phone number. Even if a user possesses a cell phone having several phone numbers, and whichever phone number is used, only one MTID can be used when the information transceiver of the cell phone is used, and the MTID of the information transceiver cannot relate to any phone number. So far, an information transceiver of a cell phone, which supports a function of sending and/or receiving messages using different phone numbers serving as CIDs (Calling IDs) or a function of relating the CIDs with different phone numbers, may do not exist on the market.

### SUMMARY OF THE INVENTION

The objective of the present application is to provide an instant communication system, aiming at the defect that information transceivers of existing cell phones don't support the function of sending and/or receiving messages using different phone numbers serving as CIDs in the prior art.

The technical solutions of the present application for solving the technical problems are as follows.

In one aspect, an instant communication system comprising an instant communication server, a plurality of mobile terminals, and a communication network is provided;

the instant communication server includes an instant communication server processor and an instant communication server memory electrically connected to the instant communication server processor;

each of the mobile terminals includes a terminal central processor, a terminal communication processor, a display unit, a terminal memory, and at least one information storage unit configured for storing a CID (Calling ID); the terminal central processor is electrically connected with the display unit and the terminal communication processor respectively; the terminal communication processor is further electrically connected with the information storage unit to obtain the CID;

each of the mobile terminals communicates with the instant communication server via the communication network; and the terminal central processor of each of the mobile terminals communicates with the instant communication server processor of the instant communication server;

when any one of the mobile terminals contacts the instant communication server for the first time, a MTID (Mobile Terminal ID) corresponding to the mobile terminal is automatically obtained by the mobile terminal, and the MTID is stored in the instant communication server memory and the terminal memory of the mobile terminal respectively;

when the mobile terminal is communicatingly connected to the instant communication server, the instant communication server obtains the CID stored in the terminal memory of the mobile terminal, and builds a map between this CID and the MTID of the mobile terminal or another of the mobile terminals;

in this instant communication system, when any one of the mobile terminals sends communication information to another of the mobile terminals using the CID mapped to the MTID of the calling mobile terminal, the calling mobile terminal sends the CID mapped to the MTID of the calling mobile terminal, the communication information, and the CID of the called mobile terminal to the instant communication server;

when the instant communication server receives the CID of the called mobile terminal, the instant communication server obtains the MTID of the called mobile terminal mapped to the CID of the called mobile terminal, and sends the CID of the calling mobile terminal and the communication information received by the instant communication server to the called mobile terminal;

when the called mobile terminal receives the CID of the calling mobile terminal and the communication information sent from the instant communication server, the CID of the calling mobile terminal and the communication information received by the called mobile terminal are shown by the display unit of the called mobile terminal.

In one embodiment, the mobile terminals are cell phones, and/or tablet computers, and/or wearable electronic devices.

In another embodiment, the communication network is mobile telecommunication network and/or the Internet.

In another embodiment, the information storage unit is a SIM card; and the CID is a telephone number.

In another embodiment, each of the mobile terminals includes an information transceiver; and the MTID is a user account of the information transceiver.

In another embodiment, the information transceiver is an IM Client.

In another embodiment, when the CID is mapped to a plurality of user accounts of the information transceivers respectively, and the instant communication server receives the communication information sent from the calling mobile terminal, the instant communication server sends the communication information to a called mobile terminal including a user account of an information transceiver last mapped to this CID.

In another aspect, a method for building a map between a CID and a MTID using the instant communication system is provided; the method includes these steps:

using a user account of an information transceiver to log in an application interface of an information transceiver; using the mobile terminal equipped with the information transceiver to deliver the user account of the information transceiver and a CID registered under the user account to the instant communication server; using the instant communication server to build a map between the user account of the information transceiver and the CID registered under the user account.

In another aspect, a method for building a map between a CID and a MTID using the instant communication system is provided; the method includes these steps:

Inserting an information storage unit storing a constant CID into an buckling recess of a vice mobile terminal configured for accommodating the information storage unit, so that the information storage unit is electrically connected to a terminal communication processor of the vice mobile terminal defining the buckling recess; using a primary mobile terminal to send a request for building a map between the stored CID and a MTID of the primary mobile terminal to the instant communication server; using the instant communication server to receive the request and send a short message including a security code to the vice mobile terminal; using the primary mobile terminal to further send the security code to the instant communication server; using the instant communication server to receive the security code sent from the primary mobile terminal and determine whether the received security code and the security code sent to the vice mobile terminal by the instant communication server are the same; if the two security codes are the same, building the map between the CID and the MTID of the primary mobile terminal.

In another aspect, a method for building a map between a CID and a MTID using the instant communication system is provided; the method includes these steps:

using a mobile terminal having a MTID (hereinafter referred to as “initial MTID”) to send a request for building a map between the initial MTID and a CID mapped to another MTID (hereinafter referred to as “objective MTID”) to the instant communication server; using the instant communication server to receive the request and send a request confirmation including a security code to a mobile terminal having the objective MTID; using the mobile terminal having the initial MTID to send the security code to the instant communication server; using the instant communication server to receive the security code sent from the mobile terminal having the initial MTID and determine whether the received security code and the security code sent to the mobile terminal having the objective MTID by the instant communication server are the same; if the two security codes are the same, building the map between the CID mapped to the objective MTID and the initial MTID.

The instant communication system of the present application achieves the objective that a mobile terminal can send and/or receive communication information using one phone number or several phone numbers. The following advantageous effect can be achieved: communications using different phone numbers of one mobile terminal can be distinguished from each other.

### BRIEF DESCRIPTION OF THE DRAWINGS

The present application will be further described with reference to the accompanying drawings and embodiments in the following, in the accompanying drawings:

FIG. 1 is a block diagram of an instant communication system of an embodiment of the present application;

FIG. 2 is a flow chart of a method for delivering information by an instant communication system of an embodiment of the present application;

FIG. 3 is a flow chart of a method for building a map between a user account of an information transceiver and a CID constantly stored in an information storage unit of a mobile terminal equipped with the information transceiver;

FIG. 4 is a schematic view of the method for delivering information by the instant communication system of the embodiment of the present application.

### DETAILED DESCRIPTION OF THE PREFERRED EMBODIMENT

An instant communication system is a communication system based on the Internet and configured to provide instant communication services for users. Generally, an instant communication system comprises an instant communication server (IM Server) and a plurality of information transceivers, wherein each of the information transceivers can be a telegraph, an instant communication client (IM Client), and so on. Each of the information transceivers establishes a communication connection with the instant communication server, and can send information to and receive information from the instant communication server. In this way, a communication system having a complicated network for delivering information is formed.

A main idea of the present application is as follows: by adopting a network architecture integrating an instant communication system with a mobile terminal communication system (the mobile terminal communication system includes a mobile telecommunication network), and building a map between one or more phone number(s) and a user account of an information transceiver, a function that mobile terminals can communicate with each other in the name of their own phone numbers using the instant communication server can be achieved.

FIG. 1 shows an instant communication system of an embodiment of the present application. The instant communication system comprises an instant communication server 1, a plurality of mobile terminals 2, and a communication network 3. Each of the mobile terminals 2 is equipped with an information transceiver (not shown).

Advantageously, in this embodiment, the instant communication server 1 includes an instant communication server processor 5 and an instant communication server memory 6 electrically connected to the instant communication server processor 5.

Furthermore, each of the mobile terminals 2 includes a terminal central processor 7, a terminal communication processor 9, a display unit 8, a terminal memory 10, and at least one information storage unit 4 configured for storing a CID (Calling ID). The terminal central processor 7 is electrically connected with the display unit 8, the terminal communication processor 9, and the terminal memory 10 respectively. The terminal communication processor 9 is further electrically connected with the information storage unit 4 to obtain the CID. The mobile terminals 2 can be cell phones, and/or tablet computers, and/or wearable electronic devices. Wherein, the cell phones can be normal cell phones or smart cell phones; and the wearable electronic devices can be smart watches (e.g., iWatch) or Google glasses. Generally, in this embodiment, the information storage unit 4 is a SIM card, and the terminal memory 10 can be a ROM or a TF card of the mobile terminal 2.

The communication network 3 is a network integrating the mobile terminals 2 with an instant communication system, and performs as a mobile telecommunication network and/or an internet in the entity structure. Wherein, the mobile telecommunication network can be a 3G or 4G cell phone network, and the internet can be a wired or wireless Wi-Fi network. In this embodiment, the communication network 3 includes communication modules respectively disposed in the instant communication server 1 and all of the mobile terminals 2, such as wired or wireless network cards, etc.

All of the mobile terminals 2 communicates with the instant communication server 1 via the communication network 3, and the terminal central processor 7 of each of the mobile terminals 2 communicates with the instant communication server processor 5 of the instant communication server 1. When any one of the mobile terminals 2 establishes a communication with the instant communication server 1 for the first time, the mobile terminal 2 automatically obtains a MTID (Mobile Terminal ID) corresponding to this mobile terminal 2, and the MTID is stored in the instant communication server memory 6 and the terminal memory 10 of this mobile terminal 2 respectively. Thus, when this mobile terminal 2 communicates with the instant communication server 1 again, this mobile terminal 2 can use its own obtained MTID to communicate with other mobile terminals 2 via the instant communication server 1.

When any one of the mobile terminals 2 establishes a communication with the instant communication server 1, the instant communication server 1 obtains the CID stored in the terminal memory 10 of this mobile terminal 2, and builds a map between this CID and the MTID of this mobile terminal 2 or the MTID of another mobile terminal 2. Generally, in this embodiment, a user can register and obtain a CID using a mobile terminal 2 by means of sending a short message in the name of a constant phone number stored in the information storage unit 4. Meanwhile, after the instant communication system communicates with the mobile terminal communication system, a map is built between the CID and the MTID of the mobile terminal 2, and this mapping relationship is stored in the instant communication server memory 6 and the terminal memory 10 of this mobile terminal 2 respectively. In this embodiment, the information storage unit 4 stores constant telephone attribute information, and the telephone attribute information includes one or more selected from an IMEI (International Mobile Equipment Identity), an IMSI (International Mobile Subscriber Identity), a MNC (Mobile Network Code), a MCC (Mobile Country Code), and a telephone number; and each of these numbers can serve as a CID. Therefore, when the MTID of the mobile terminal 2 is mapped to the CID of the mobile terminal 2 by the instant communication server processor 5 of the instant communication server 1, the mobile terminal 2 can use the MTID of the mobile terminal 2 to communicate with other mobile terminals 2 in the name of the CID mapped to the MTID of the mobile terminal 2.

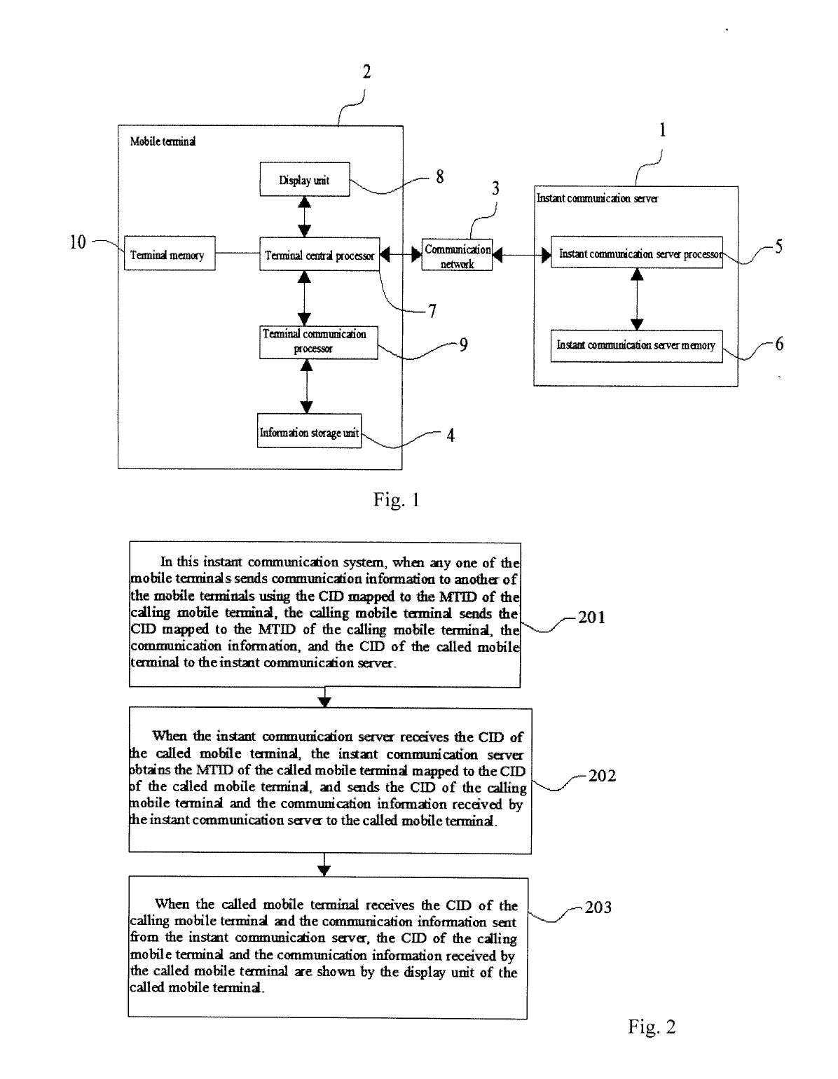

Furthermore, FIG. 2 shows a method for delivering information by the instant communication system of the present application, and this method includes steps 201, 202, and 203 as follows.

Step 201: in the aforementioned instant communication system, when any one of the mobile terminals (hereinafter referred to as “calling mobile terminal”) sends communication information to another mobile terminal (hereinafter referred to as “called mobile terminal”) using the CID mapped to the MTID of the calling mobile terminal, the calling mobile terminal sends the CID mapped to the MTID of the calling mobile terminal, the communication information, and the CID of the called mobile terminal to the instant communication server.

Generally, before implementing step 201, a user account of the information transceiver needs to be registered. Wherein, the MTID is the user account of this information transceiver.

After the user account of the information transceiver is registered and a correct password is input, the information transceiver can be used. Generally, every mobile terminal has only one user account of the information transceiver.

For implementing step 201 more easily, the mobile terminal can control the information storage unit via the information transceiver; and for protecting users' personal privacy, in this embodiment, a user can login the information transceiver using the telephone attribute information of the information storage unit, and thus obtain a CID. Thus, the situation that the information storage unit is automatically detected and identified by the terminal communication processor, which may cause leakage of the user's privacy in communications between the mobile terminal communication and the instant communication system, can be prevented. The user can also obtain a CID by a method of sending a short message using the telephone attribute information of the information storage unit.

Generally, an address, a port number, and a login time of the information transceiver presently logged in by a user correspond to the MTID corresponding to this information transceiver. The address, the port number, and the login time of the information transceiver presently logged in by the user, the MTID corresponding to this information transceiver, and the CID mapped to this MTID are stored in the instant communication server of the instant communication system. Thus, when the instant communication server receives a CID and communication information sent in the name of this CID, the MTID mapped to the CID, and information such as the address and the port number of the information transceiver corresponding to the MTID can be obtained, so that the communication information can be precisely sent to a predetermined mobile terminal.

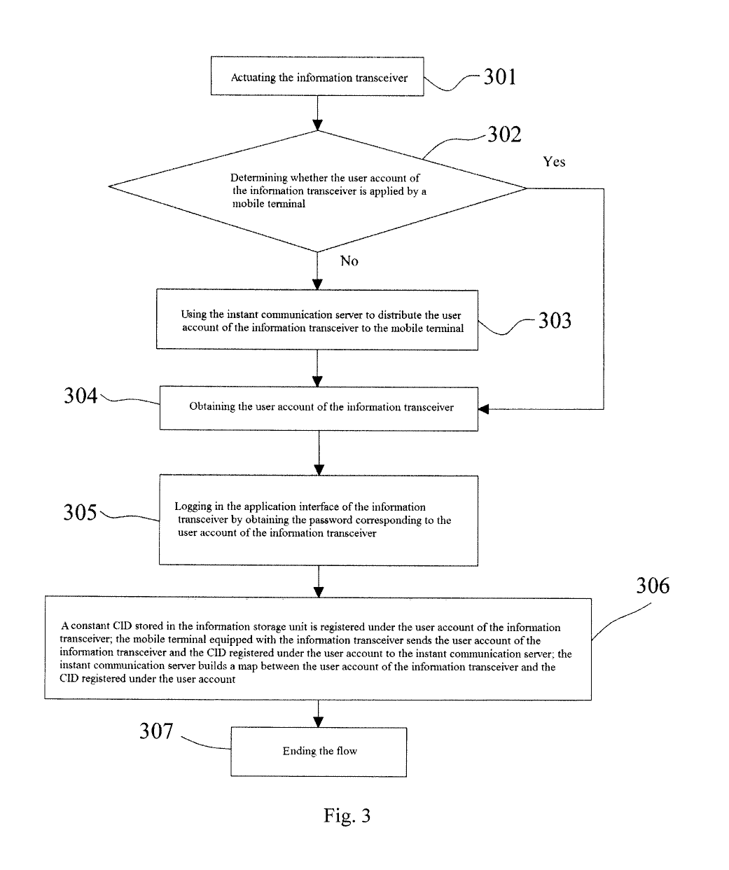

In order to make the present application be understood more clearly, as shown in FIG. 3, the present application describes a method for building a map between a user account of an information transceiver and a CID, the method includes these steps.

Step 301: actuating the information transceiver, and then entering Step 302.

Step 302: determining whether the user account of the information transceiver is applied by a mobile terminal; if the user account is applied, entering step 304; if the user account is not applied, entering step 303. Step 302 can be performed by communications between the mobile terminal and the instant communication server.

Step 303: using the instant communication server to distribute the user account of the information transceiver to the mobile terminal, and entering step 304. Step 303 can be completed by user's application and communications between the mobile terminal and the instant communication server. Generally, as the instant communication server distributes the user account, the user sets a password corresponding to the user account.

Step 304: obtaining the user account of the information transceiver, and entering Step 305.

Step 305: logging in the application interface of the information transceiver by obtaining the password corresponding to the user account of the information transceiver, and entering Step 306; when the obtained password doesn't correspond to the user account of the information transceiver, repeating step 305.

Step 306: a constant CID stored in the information storage unit is registered under the user account of the information transceiver; the mobile terminal equipped with the information transceiver sends the user account of the information transceiver and the CID registered under the user account to the instant communication server; the instant communication server builds a map between the user account of the information transceiver and the CID registered under the user account; and entering step 307. Wherein, the CID can be registered by a short message or by internet submitting.

Step 307: ending the flow.

Thus, a map is built between the user account of the information transceiver and the CID registered under the user account. In this procedure, when the mobile terminal has only one buckling recess configured for accommodating the information storage unit (when the information storage unit is inserted in the buckling recess, the information storage unit is electrically connected to the terminal communication processor of the mobile terminal defining the buckling recess; and the buckling recess can be a recess for a SIM card), a user can obtain and activate a CID by inserting an information storage unit in the mobile terminal under the user account of the information transceiver of the mobile terminal, and further remove this information storage unit and activate another CID by inserting another information storage unit in the mobile terminal, so that the user account of the information transceiver of the mobile terminal having only one buckling recess configured for accommodating an information storage unit is mapped to a plurality of CIDs.

It can be understood that when the mobile terminal is provided with n (n is a positive integer) buckling recesses, more than n CIDs can be activated by the aforementioned method of changing the information storage unit, so that the user account of the information transceiver of the mobile terminal having the n buckling recesses is mapped to the more than n CIDs.

The present further provides a CID activation method: if a map should be built between a user account (hereinafter referred to as “MTID Z”) of an information transceiver of a mobile terminal (hereinafter referred to as “primary mobile terminal”) and a CID, an information storage unit stably storing the CID can be inserted into an buckling recess of another mobile terminal (hereinafter referred to as “vice mobile terminal”, wherein the vice mobile terminal may be not equipped with an information transceiver) configured for accommodating information storage units. Thus, the information transceiver of the primary mobile terminal is logged in using the MTID Z, and the primary mobile terminal sends a request for building a map between this CID and the MTID Z to the instant communication server. Upon receiving the request, the instant communication server send a short message including a security code to the vice mobile terminal via the mobile telecommunication network. At the same time, the primary mobile terminal sends the security code to the instant communication server. Upon receiving the security code sent from the primary mobile terminal, the instant communication server determines whether this received security code and the security code sent from the instant communication server to the vice mobile terminal are the same; if the two security codes are the same, the map between this CID and the MTID Z is built.

Step 202: when the instant communication server receives the CID of the called mobile terminal, the instant communication server obtains the MTID of the called mobile terminal mapped to the CID of the called mobile terminal, and sends the CID of the calling mobile terminal and the communication information received by the instant communication server to the called mobile terminal.

The CID of the called mobile terminal can correspond to the recipient of the communication information. For example, as the phone number of the recipient of the communication information is 13402000000, the CID of the called mobile terminal can be 13402000000.

In modern society, a person may frequently change his/her cell phone, and therefore an information storage unit (such as a SIM card) of the called mobile terminal may be often removed from one cell phone and inserted in another cell phone. Thus, in the instant communication server, one CID may be mapped to user accounts of a plurality of information transceivers. Therefore, if this problem is not solved, the communication information may be respectively sent to a plurality of mobile terminals that are respectively equipped with the plurality of information transceivers mapped to the CID of the called mobile terminal, which may adversely affect the security of the communication information. To solve this problem, when the instant communication server receives the communication information sent from the calling mobile terminal, the instant communication server sends the communication information to the called mobile terminal including the user account of the last information transceiver mapped to this CID. Thus, the communication information is sent to only one mobile terminal.

Of course, in reality, a user may possess several cell phones. When such a user turns off one cell phone and uses another, the communication information sent to the CID corresponding to the turned-off cell phone cannot be received by this user in time. To solve this problem, the instant communication server can build a map between a CID (such as CID X) that has already been mapped to a MTID (such as MTID X) and another MTID (such as MTID Y). Thus, the MTID Y can receive communication information sent to the CID X. Specifically, the number of the CIDs can be more than one. A method for building a map between a CID that has already been mapped to a MTID and another MTID is described herein, and the method includes these steps:

using a mobile terminal having one MTID (hereinafter referred to as “initial MTID”) to send a request for building a map between the initial MTID and a CID that has already been mapped to another MTID (hereinafter referred to as “objective MTID”) to the instant communication server; upon receiving the request, the instant communication server sends a request confirmation including a security code to a mobile terminal having the objective MTID; thus, the mobile terminal having the initial MTID sends the security code to the instant communication server; the instant communication server receives the security code sent from the mobile terminal having the initial MTID, and determines whether the received security code and the security code sent from the instant communication server to the mobile terminal having the objective MTID are the same; if the two security code are the same, the map between the CID mapped to the objective MTID and the initial MTID is built.

Thus, the mobile terminal having the initial MTID can receive the communication information sent to the CID mapped to the objective MTID.

Step 203: when the called mobile terminal receives the CID of the calling mobile terminal and the communication information sent from the instant communication server, the CID of the calling mobile terminal and the communication information received by the called mobile terminal are displayed by the display unit of the called mobile terminal.

Generally, the communication information is displayed on the application interface of the information transceiver installed in the mobile terminal.

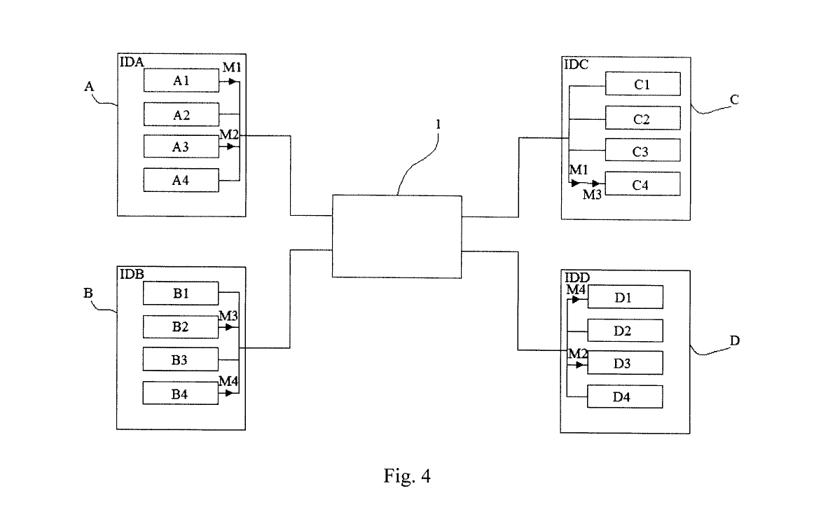

In order to make the present application be understood more clearly, as shown in FIG. 4, the method for delivering the communication information via the instant communication system of the present application is described according to a specific embodiment. The CID is a telephone number herein.

FIG. 4 shows a mobile terminal A, a mobile terminal B, a mobile terminal C, and a mobile terminal D. The application interfaces of the IM clients of the mobile terminal A, the mobile terminal B, the mobile terminal C and the mobile terminal D are all logged in.

Wherein, an application account of the IM client of the mobile terminal A is IDA; an application account of the IM client of the mobile terminal B is IDB; an application account of the IM client of the mobile terminal C is IDC; and an application account of the IM client of the mobile terminal D is IDD.

Furthermore, each of the mobile terminal A, the mobile terminal B, the mobile terminal C, and the mobile terminal D has four SIM cards mounted therein. Particularly, the four SIM cards of the mobile terminal A correspond to four phone numbers, which are the phone number A1, the phone number A2, the phone number A3, and the phone number A4. The phone number A1, the phone number A2, the phone number A3 and the phone number A4 are all mapped to the application account IDA. The four SIM cards of the mobile terminal B correspond to four phone numbers, which are the phone number B1, the phone number B2, the phone number B3 and the phone number B4. The phone number B1, the phone number B2, the phone number B3 and the phone number B4 are all mapped to the application account IDB. The four SIM cards of the mobile terminal C correspond to four phone numbers, which are the phone number C1, the phone number C2, the phone number C3 and the phone number C4. The phone number C1, the phone number C2, the phone number C3 and the phone number C4 are all mapped to the application account IDC. The four SIM cards of the mobile terminal D correspond to four phone numbers, which are the phone number D1, the phone number D2, the phone number D3 and the phone number D4. The phone number D1, the phone number D2, the phone number D3 and the phone number D4 are all mapped to the application account IDD.

The phone number A1, the phone number A2, the phone number A3, the phone number A4 and their application interfaces are all displayed on the application interface of the IM client of the mobile terminal A; the phone number B1, the phone number B2, the phone number B3, the phone number B4 and their application interfaces are all displayed on the application interface of the IM client of the mobile terminal B; the phone number C1, the phone number C2, the phone number C3, the phone number C4 and their application interfaces are all displayed on the application interface of the IM client of the mobile terminal C; and the phone number D1, the phone number D2, the phone number D3, the phone number D4 and their application interfaces all displayed on in the application interface of the IM client of the mobile terminal D.

The mobile terminal A, the mobile terminal B, the mobile terminal C, and the mobile terminal D communicate with the instant communication server 1 via a communication network respectively. Any one of the mobile terminal A, the mobile terminal B, the mobile terminal C, and the mobile terminal D can sends communication information edited in the application interface of the IM client thereof to a called mobile terminal in the name of any one of the phone numbers mapped to the user account of the IM client, and this phone number and this communication information are displayed on the application interface of the IM client of the called mobile terminal. For example, the mobile terminal A sends first communication information M1 to the mobile terminal C possessing the phone number C4 in the name of the phone number A1, and the mobile terminal A also sends second communication information M2 to the mobile terminal D possessing the phone number D3 in the name of the phone number A3. Similarly, the mobile terminal B sends third communication information M3 to the mobile terminal C possessing the phone number C4 in the name of the phone number B2, and the mobile terminal B also sends fourth communication information M4 to the mobile terminal D possessing the phone number D1 in the name of the phone number B4. Thus, the objective that a mobile terminal is enabled to deliver communication information in the name of one or more phone number(s) of the mobile terminal is achieved by the instant communication system of the present application.

While the embodiments of the present application are described with reference to the accompanying drawings above, the present application is not limited to the above-mentioned specific implementations. In fact, the above-mentioned specific implementations are intended to be exemplary not to be limiting. In the inspiration of the present application, those ordinary skills in the art can also make many modifications without breaking away from the subject of the present application and the protection scope of the claims. All these modifications belong to the protection of the present application.

1. An instant communication system, comprising: an instant communication server, a plurality of mobile terminals, and a communication network;
wherein, the instant communication server includes an instant communication server processor and an instant communication server memory electrically connected to the instant communication server processor;
each of the mobile terminals includes a terminal central processor, a terminal communication processor, a display unit, a terminal memory, and at least one information storage unit configured for storing a CID (Calling ID); the terminal central processor is electrically connected with the display unit and the terminal communication processor respectively; the terminal communication processor is further electrically connected with the information storage unit to obtain the CID;
each of the mobile terminals communicates with the instant communication server via the communication network; and the terminal central processor of each of the mobile terminals communicates with the instant communication server processor of the instant communication server;
when any one of the mobile terminals contacts the instant communication server for the first time, a MTID (Mobile Terminal ID) corresponding to the mobile terminal is automatically obtained by the mobile terminal, and the MTID is stored in the instant communication server memory and the terminal memory of the mobile terminal respectively;
when the mobile terminal is communicatingly connected to the instant communication server, the instant communication server obtains the CID stored in the terminal memory of the mobile terminal, and builds a map between this CID and the MTID of the mobile terminal or another of the mobile terminals;
in this instant communication system, when any one of the mobile terminals sends communication information to another of the mobile terminals using the CID mapped to the MTID of the calling mobile terminal, the calling mobile terminal sends the CID mapped to the MTID of the calling mobile terminal, the communication information, and the CID of the called mobile terminal to the instant communication server;
when the instant communication server receives the CID of the called mobile terminal, the instant communication server obtains the MTID of the called mobile terminal mapped to the CID of the called mobile terminal, and sends the CID of the calling mobile terminal and the communication information received by the instant communication server to the called mobile terminal;
when the called mobile terminal receives the CID of the calling mobile terminal and the communication information sent from the instant communication server, the CID of the calling mobile terminal and the communication information received by the called mobile terminal are shown by the display unit of the called mobile terminal.

2. The instant communication system according to claim 1, wherein, the mobile terminals are cell phones, and/or tablet computers, and/or wearable electronic devices.

3. The instant communication system according to claim 1, wherein, the communication network is mobile telecommunication network and/or the Internet.

4. The instant communication system according to claim 3, wherein, the information storage unit is a SIM card; and the CID is a telephone number.

5. The instant communication system according to claim 4, wherein, each of the mobile terminals includes an information transceiver; and the MTID is a user account of the information transceiver.

6. The instant communication system according to claim 5, wherein, the information transceiver is an IM Client.

7. The instant communication system according to claim 6, wherein, when the CID is mapped to a plurality of user accounts of the information transceivers respectively, and the instant communication server receives the communication information sent from the calling mobile terminal, the instant communication server sends the communication information to a called mobile terminal including a user account of an information transceiver last mapped to this CID.

8. A method for building a map between a CID and a MTID using the instant communication system according to claim 6, wherein, the method includes these steps:
using a user account of an information transceiver to log in an application interface of an information transceiver; using the mobile terminal equipped with the information transceiver to deliver the user account of the information transceiver and a CID registered under the user account to the instant communication server; using the instant communication server to build a map between the user account of the information transceiver and the CID registered under the user account.

9. A method for building a map between a CID and a MTID using the instant communication system according to claim 6, wherein, the method includes these steps:
Inserting an information storage unit storing a constant CID into an buckling recess of a vice mobile terminal configured for accommodating the information storage unit, so that the information storage unit is electrically connected to a terminal communication processor of the vice mobile terminal defining the buckling recess; using a primary mobile terminal to send a request for building a map between the stored CID and a MTID of the primary mobile terminal to the instant communication server; using the instant communication server to receive the request and send a short message including a security code to the vice mobile terminal; using the primary mobile terminal to further send the security code to the instant communication server; using the instant communication server to receive the security code sent from the primary mobile terminal and determine whether the received security code and the security code sent to the vice mobile terminal by the instant communication server are the same; if the two security codes are the same, building the map between the CID and the MTID of the primary mobile terminal.

10. A method for building a map between a CID and a MTID using the instant communication system according to claim 6, wherein, the method includes these steps:
using a mobile terminal having a MTID (hereinafter referred to as “initial MTID”) to send a request for building a map between the initial MTID and a CID mapped to another MTID (hereinafter referred to as “objective MTID”) to the instant communication server; using the instant communication server to receive the request and send a request confirmation including a security code to a mobile terminal having the objective MTID; using the mobile terminal having the initial MTID to send the security code to the instant communication server; using the instant communication server to receive the security code sent from the mobile terminal having the initial MTID and determine whether the received security code and the security code sent to the mobile terminal having the objective MTID by the instant communication server are the same; if the two security codes are the same, building the map between the CID mapped to the objective MTID and the initial MTID.
